(19) United States
(12) Patent Application Publication
(10) Pub. No.: US 2006/0211395 A1
(43) Pub. Date: Sep. 21, 2006

(54) Apparatus and method of detecting pilot carriers received on a fading channel

(75) Inventor: Alan Waltho, San Jose, CA (US)

Correspondence Address: PEARL COHEN ZEDEK LATZER, LLP, 1500 BROADWAY, 12TH FLOOR, NEW YORK, NY, 10036, US

(73) Assignee: INTEL CORPORATION

(21) Appl. No.: 11/079,317

(22) Filed: Mar. 15, 2005

(51) Int. Cl. H04B 1/44; H04B 7/08; H04B 1/06

(52) U.S. Cl. 455/277.1; 455/140; 455/83

(57) ABSTRACT

Briefly, a method, apparatus and cognitive radio system to detect a pilot carrier and/or a pilot tone in fading channel conditions by diverting a phase center of an antenna from a first point in space to a second point in space.

### BACKGROUND OF THE INVENTION

In licensed broadcasting bands, for example, television (TV) broadcast bands, it may be possible for unlicensed wireless devices to operate, on a non interfering basis, on channels unoccupied by TV stations. In order to operate on a vacant broadcast channel the unlicensed device must determine which channels are unoccupied by the broadcast television stations at its specific location. The wireless devices that operate on the vacant broadcast bands may include cognitive radio systems. The cognitive radio system may operate by detection of an artifact of the broadcast signal such as the pilot carrier of a digital TV signal and/or a video carrier of an analog TV signal. The narrow bandwidth of the pilot carrier and/or video carrier signal may permit the use of highly sensitive narrow band detectors to ensure a low probability of failure to detect the signal of a broadcasting station

Depending on the precise location of an antenna of the unlicensed wireless device such pilot carrier and/or video carrier signal may be deeply faded due to multipath propagation. Such deep fading may occur when the signal at the antenna is a vector sum of two multipath signal components with the same amplitude but opposite in phase.

Various models known in the art may be used to calculate the probability of detection versus the fade depth. A sensitivity of the cognitive radio device may be increased through the use of a reduced filter bandwidth, or other noise averaging techniques, to address the fade depth applicable to any desired probability of detection. The consequence of this increased sensitivity is that under more benign conditions detection of very distant transmitters may occur.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention; and

FIG. 2 is a schematic block diagram of a wireless communication device according to some exemplary embodiments of the present invention;

FIG. 3 is a schematic block diagram of a wireless communication device according to some other exemplary embodiments of the present invention; and

FIG. 4 is a schematic graph helpful in demonstrating exemplary narrow band fade versus antenna separation according to embodiments of the present invention. invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

It should be understood that the present invention may be used in a variety of applications. Although the present invention is not limited in this respect, the circuits and techniques disclosed herein may be used in many apparatuses such as mobile communication devices of a radio system. Mobile communication devices intended to be included within the scope of the present invention include, by way of example only, wireless local area network (WLAN) devices, unlicensed two-way radio devices, digital system mobile devices, and the like.

Types of Mobile communication devices intended to be within the scope of the present invention include, although are not limited to, mobile stations, software defined radios (SDR), cognitive radios and the like.

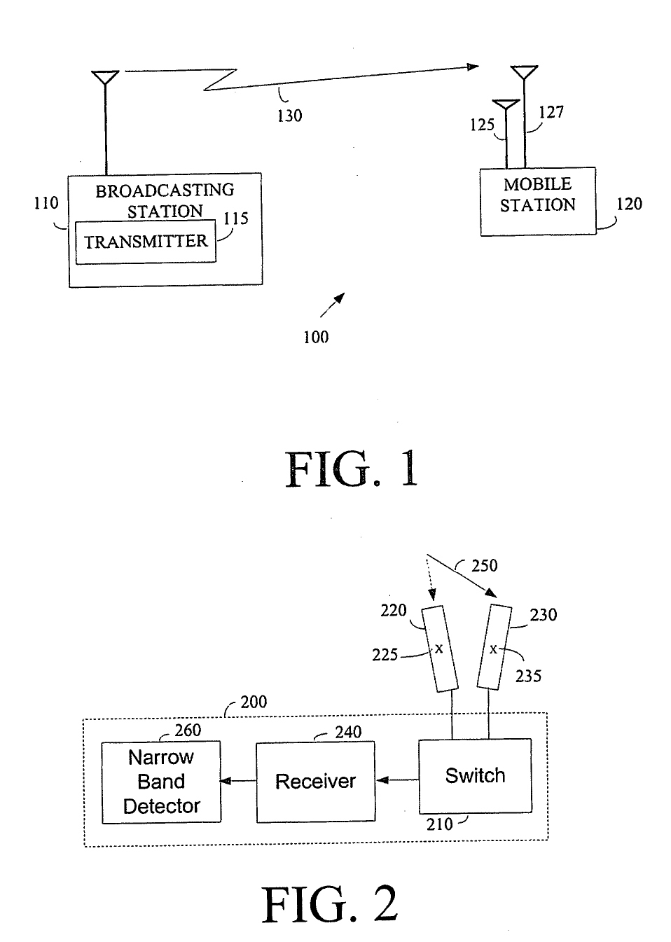

Turning first to FIG. 1, a wireless communication system 100, for example, a wireless communication system that may operate on an unlicensed service basis within a frequency band otherwise assigned to licensed services, according to embodiments of the present invention, is shown. Although the scope of the present invention is not limited in this respect, an exemplary wireless communication system according to embodiments of the invention may include one or mole broadcasting stations, for example a television (TV) broadcast station 110 and one or more mobile stations, for example a mobile station 120. According to some embodiments of the invention, broadcasting station 110 may include a transmitter 115 to transmit a pilot signal 130, which may be carried over a pilot carrier. Detection of the pilot carrier by mobile station 120 may be used to indicate when a channel of broadcasting station 110 is occupied, if desired. Mobile station 120 may include one antenna with two or more phase centers and/or two or more antennas 125, 127 with separate phase centers that may be used to detect and receive pilot signal 130. Furthermore, antennas 125, 127 may be used to transmit and/or receive communications over an unoccupied channel, although the scope of the present invention is not limited to this example.

Although the scope of the present invention is not limited in this respect, antennas 125, 127 may include omni-directional antennas in the form of: a folded monopole antenna, a folded dipole antenna, a planar inverted F antenna, a patch antenna, or the like.

Turning to FIG. 2, a schematic block diagram of a wireless communication device 200, for example, a cognitive radio device and/or system according to some exemplary embodiments of the present invention is shown. Although the scope of the present invention is not limited in this respect, wireless communication device 200 may include a switch 210 to switch antennas or antenna phase centers 220, 230, a receiver 240 to receive a pilot signal 250 (e.g., a pilot carrier) and a narrow band detector 260 to detect pilot signal 250, if desired. Pilot signal 250 (e.g. pilot carrier and/or a pilot tone) may indicate an occupancy of a broadcasting channel, if desired.

Although the scope of the present invention is not limited in this respect, in some embodiments of the present invention, antenna 220 may have a phase center 225 and antenna 230 may have a phase center 235. According to exemplary embodiments of the present invention, phase center 225 of antenna 220 may be shifted a predetermined distance from phase center 235 of antenna 230, for example, about 0.025 wavelengths, if desired. In some embodiments of the invention, for example, the phase centers may be co-positioned such that pilot signal 250 may be deeply faded at phase center 225 of antenna 220 and substantially non-faded at phase center 235 of antenna 230 (shown with the dotted line). In this configuration, antenna switch 210 may switch antennas 220, 230 at a suitable switching rate to receive the unfaded signal by at least one antenna of antennas 220, 230. In this embodiment of the invention receiver 240 may receive and demodulate and/or process signals received from at least one of the antennas 220, 230, and narrow band detector 240 may detect pilot signal 250.

Although the scope of the present invention is not limited in this respect, receiver 240 may include NTSC, VSB, or OFDM receivers that may operate as a Wireless Local Area Network (WLAN) and/or Wireless Wide Area Network (which may be also referred as WiMAX), if desired.

Although the scope of the present invention is not limited in this respect, narrow band detector 260 may include a narrow band filter and/or may employ a time averaging mechanism to detect the pilot carrier and/or pilot tone and/or a video carrier, if desired.

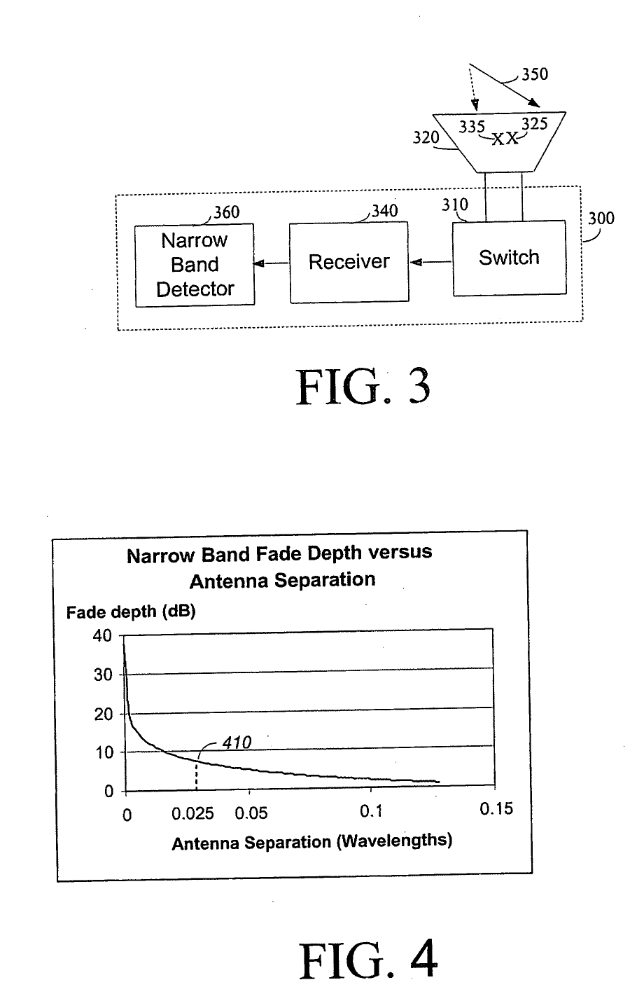

Turning to FIG. 3, a schematic block diagram of a wireless communication device 300, for example, a cognitive radio device according to some other exemplary embodiments of the present invention is shown. Although the scope of the present invention is not limited in this respect, wireless communication device 300 may include a switch 310 to switch an antenna 320, a receiver 340 to receive a signal 350, which may include a pilot carrier and/or a narrow band pilot tone, and a narrow band detector 360 to detect the narrow band pilot signal, if desired.

Although the scope of the present invention is not limited in this respect, in some embodiments of the present invention, antenna 320 may include a diversity antenna which includes two or more phase centers, for example phase centers 325, 335. According to this exemplary embodiment of the present invention, phase center 325 may be shifted a predetermined distance from phase center 335, for example, about 0.025 wavelengths, if desired. In some embodiments of the invention, for example, pilot carrier 350 may be deeply faded at phase center 325 and substantially non-faded at phase center 335 (shown with the dotted line). In this configuration, antenna switch 310 may switch phase centers 325, 335 at a suitable and/or predetermined switching rate to receive the non-faded signal. In this embodiment of the invention receiver 340 may receive and demodulate and/or process signals received from antenna 320 and narrow band detector 340 may detect a narrow band pilot tone of the pilot carrier (e.g. signal 350), if desired. Furthermore, antenna switch 310 may divert phase center 325 or 335 of the diversity antenna from a first point in space to a second point in space at a switching rate which enables detection of the pilot tone in a fading channel conditions.

Although the scope of the present invention is not limited in this respect, antenna 320 may be referred to herein as a diversity antenna. According to one exemplary embodiments of the present invention, signal 350 may include a narrow band pilot tone and the fade depth for the narrow band pilot tone may be reduced to less than 6 dB for a separation of antenna phase centers of only 0.025 wavelengths, although the scope of the present invention is in no way limited to this example.

Although the scope of the present invention is not limited in this respect, antenna switch 310 may use one or more techniques to separate and/or to switch and/or to divert antenna phase centers 325, 335 from a first point in space to a second point in space at a determined switching rate to enable detection of the faded pilot tone. For example, antenna switch 310 may operate to cause an antenna feed point (e.g., of antenna 320) to be moved from one location of the antenna to another. In some other exemplary embodiments of the present invention, antenna switch 310 may be used to modify the geometry of the antenna, if desired. In yet some other exemplary embodiments of the present invention, antenna switch 310 may be used to move the phase center of the antenna, although the scope of the present invention is not limited to the above described exemplary embodiments of the invention.

Turning to FIG. 4, a schematic graph showing narrow band fade versus antenna separation according to exemplary embodiments of the present invention is shown. According to this graph, the narrow band fade is maximal when there is no antenna separation and is reduced less than 10 db for an antenna separation of 0.0025 wavelength 410. According to exemplary embodiments of the invention, antenna switch 310 may divert antenna phase centers 325, 335 from a first point in space to a second point in space according to a desired antenna separation value and/or according to a requested probability of detection of the pilot carrier under the narrow band fade conditions.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus comprising:
an antenna switch to divert a phase center of an antenna from a first point in space to a second point in space at a switching rate that enables detection of a pilot carrier received on a fading channel.

2. The apparatus of claim 1, comprising:
a receiver to detect occupancy of a broadcasting channel by detecting a signal that includes the pilot carrier; and
a narrow band detector to detect the pilot carrier.

3. The apparatus of claim 2, wherein the broadcasting channel includes a television broadcasting channel.

4. The apparatus of claim 1 associated with a cognitive radio device and comprising:
first and second antennas coupled to the antenna switch, the first antenna having a first phase center, the second antenna having a second phase center,
wherein the antenna switch is able to switch between the first and second antennas.

5. The apparatus of claim 1 associated with a cognitive radio device and comprising:
a diversity antenna coupled to the antenna switch,
wherein the antenna switch is able to divert a phase center of the diversity antenna from a first point in space to a second point in space at a switching rate.

6. A cognitive radio system comprising:
a diversity antenna to receive a pilot carrier which includes a pilot tone to indicate an occupancy of a broadcasting channel; and
an antenna switch to divert a phase center of the diversity antenna from a first point in space to a second point in space at a switching rate to enable detection of the pilot tone in a fading channel conditions.

7. The cognitive radio system of claim 6, comprising:
a receiver to receive the pilot signal; and
a narrow band detector to detect the pilot tone.

8. The cognitive radio system of claim 6, wherein the broadcasting channel is a television broadcasting channel.

9. A cognitive radio system comprising:
first and second omni-directional antennas, wherein the first antenna includes a first phase center and the second antenna includes a second phase center; and
an antenna switch to switch between the first and second antennas to detect a pilot carrier received on a fading channel.

10. The cognitive radio system of claim 9, wherein the first and second phase centers of the first and second antennas are shifted in space a predetermined distance.

11. The cognitive radio system of claim 9, comprising:
a receiver to receive a signal that includes the pilot carrier; and
a narrow band detector to detect the pilot carrier.

12. The cognitive radio system of claim 11, wherein the pilot carrier includes a pilot tone and wherein the narrow band detector is able to detect the pilot tone.

13. The cognitive radio system of claim 9, wherein the system is able to detect occupancy of a broadcasting channel by detecting a pilot tone of said pilot carrier.

14. The cognitive radio system of claim 13, wherein the broadcasting channel is a television broadcasting channel.

15. A method comprising:
detecting a pilot carrier in fading channel conditions by diverting a phase center of an antenna from a first point in space to a second point in space at a switching rate.

16. The method of claim 15, wherein detecting comprises:
detecting a signal within said pilot carrier indicating occupancy of a broadcasting channel.

17. The method of claim 1S, comprising:
shifting the phase center of the antenna a predetermined distance.

18. A method comprising:
detecting a pilot carrier in fading channel conditions by switching between a first antenna having a first phase center and a second antenna having a second phase center.

19. The method of claim 18, wherein detecting comprises:
detecting a signal within said pilot carrier indicating occupancy of a broadcasting channel.

20. The method of claim 18, comprising:
shifting the phase center of the antenna a predetermined distance.
